(19) United States
(12) Patent Application Publication
(10) Pub. No.: US 2014/0111334 A1
(43) Pub. Date: Apr. 24, 2014

(54) SENSOR POD

(71) Applicant: Hutchison International Ports Enterprises Limited, Road Town (VG)

(72) Inventors: Ryan Scott Luong Carpenter, Mid-Levels (CN); Nicholas D. Cova, Salt Lake City, UT (US)

(21) Appl. No.: 13/655,202

(22) Filed: Oct. 18, 2012

(51) Int. Cl. G08B 13/14; F16M 13/02; G08B 1/08

(52) U.S. Cl. 340/539.26; 340/572.1; 340/539.1; 248/689

(57) ABSTRACT

A sensor pod includes a housing defining an interior cavity; a fixture configured to attach the housing to a surface; an infrared sensor in the cavity configured to monitor infrared light through a first port in the housing; and a monitoring system disposed in the interior cavity and configured to receive a signal from the infrared sensor and determine whether the housing has been detached from the surface based on the signal, and to generate an alert signal when the housing is determined to have been detached from the surface.

### TECHNICAL FIELD

This specification generally relates to monitoring the environment of an enclosure.

### BACKGROUND

Shipping containers are used to transport goods all over the world. For example, shipping containers can be placed on the back of trucks, on cargo ships, on trains and other vehicles. Because the goods transported in the shipping containers can be valuable, the shipping containers are often secured and/or monitored by various mechanical and electronic devices. These devices can be configured to detect when a shipping container has been opened or tampered with and report the status of the shipping container to users charged with ensuring the shipping containers reach their destinations with their goods intact.

### SUMMARY

This specification describes technologies related to systems, apparatus, and methods for monitoring the environment of an enclosure. In one aspect, the invention features a sensor pod, including: a housing defining an interior cavity; a fixture configured to attach the housing to a surface; an infrared sensor in the cavity configured to monitor infrared light through a first port in the housing; and a monitoring system disposed in the interior cavity and configured to receive a signal from the infrared sensor and determine whether the housing has been detached from the surface based on the signal, and to generate an alert signal when the housing is determined to have been detached from the surface.

In some examples, the fixture includes at least one magnet positioned on a back face of the housing. In some cases, the at least one magnet includes a plurality of magnets, and the first port is positioned between the magnets.

In some applications, the fixture includes mounting hardware.

In some cases, the fixture includes a clip assembly having a frame and a clip, the frame configured to be slidably and detachably secured to the housing without blocking the port, the clip pivotally mounted to the frame.

In some implementations, light sensor configured to monitor through port in the housing. In some applications, the sensor pod further includes a temperature sensor other than the IR and light sensor.

In some embodiments, the alert signal is a wireless signal.

In some applications, the housing has two opposing side faces, each of the side faces defining a recess adjacent a back side of the housing for user to grip and detach the housing from the surface.

In some cases, the sensor pod further includes a temperature and humidity sensor.

In some examples, the sensor pod further includes a battery status sensor and a batter status indicator.

In some applications, the sensor pod further includes a sensor configured to monitor a physical status of the housing, the sensor being selected from the group consisting of an accelerometer, a gyroscope, a vibration sensor, and a shock sensor.

In some implementations, the sensor pod further includes a sensor configured to monitor a surrounding environment of the housing, the sensor being selected from the group consisting of an ammonia sensor, a carbon dioxide sensor, a fumigant sensor, a radiation sensor, and a pressure sensor.

In some embodiments, the sensor pod further includes a security sensor being selected from the group consisting of a motion sensor, a sound sensor, a still shot camera, a video camera, and an ambient radio frequency sensor.

In another aspect, the invention features, a sensor pod, including: a housing defining an interior cavity; a sensor in the cavity configured to sense one or more of temperature, humidity, acceleration/shock or visible light through a port in the housing; an RFID tag; a wireless personal area network transceiver in the cavity; a network transceiver in the cavity; and a communication control system in the cavity. The communication control system is configured to i) determine whether a remote device is associated with the sensor pod by detecting whether a message from the remote device received wireless personal area network transceiver by the matches an ID of the RFID card, and establish communication through the wireless personal area network transceiver with the associated remote device; ii) determine whether no communication has been received from an associated remote device for longer than a first preset time period, and attempt to establish communication through the wireless personal area network transceiver with another remote device, and iii) determine whether no communication through the wireless personal area network transceiver has been established with the another remote device, and attempt to establish communication with a remote server via the network transceiver.

In some examples, the communication control system is further configured to send measurements made by the sensor to whichever of the associated remote device, another remote device and remote server with which communication has been established.

In some applications, the wireless personal area network transceiver include a Zigbee transceiver.

In some cases, the network transceiver includes a cellular network transceiver.

In some implementations, the network transceiver includes a Satcomm transceiver.

In yet another aspect, the invention features a sensor pod kit, including: a sensor pod including a housing defining an interior cavity and a sensor in the cavity configured to sense one or more of temperature, humidity or visible light through a port in the housing; and a clip assembly having a frame and a clip, the frame configured to be slidably and detachably secured to the housing without blocking the port, the clip pivotally mounted to the frame.

In some examples, the clip is movable between a first position substantially perpendicular to the frame and a second position substantially parallel to the frame. In some cases, the kit further includes a snap mechanism to hold the clip in the first position or the second position.

In some applications, the frame is configured to surround the housing when secured to the housing. In some examples, the housing is generally a rectangular solid, frame has opposing rails that slide along two sides of the housing.

In some cases, the kit further includes a snap mechanism to hold the frame on the housing.

In some implementations, the kit further includes an infrared sensor in the cavity configured to monitor infrared light through a port in a back side of the housing. In some cases, the frame defines a recess extending from a lower edge so that the infrared sensor is not covered when the clip assembly is attached to the housing.

In some embodiments, the kit further includes at least one other sensor disposed within the interior housing and configured to sense acceleration, vibration or shock.

In some applications, the kit further includes a battery pack configured to be releasably coupled to the housing to power the sensor.

In some cases, the kit further includes an assortment of battery packs, each battery pack of the assortment having a different power capacity.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a rear view of a sensor pod for monitoring environmental conditions within an enclosure.

FIG. 1B is a front view of the sensor pod of FIG. 1A.

FIGS. 1C and 1D are side views of the sensor pod of FIGS. 1A and 1B.

FIG. 1E is a cross-sectional view of the sensor pod of FIGS. 1A-1D.

FIG. 2 is a flow chart illustrating a communication control protocol.

FIG. 3A is a rear view of a sensor pod featuring an attachment assembly.

FIG. 3B is a side view of the sensor pod of FIG. 3A.

One or more of the illustrated system components may be exaggerated to better show the features, process steps, and results achieved by embodiments of the present disclosure.

### DETAILED DESCRIPTION

One or more implementations of the present disclosure provide a sensor pod device designed to monitor the environmental conditions inside of sealed enclosures. Such enclosures can include, but are not limited to, shipping containers and the like. In some examples, when the sensor pod detects a change in the environmental conditions inside an enclosure, the sensor pod can transmit (i.e., report) environmental data describing the change in the internal environment to an authorized receiver. The sensor pod might also report environmental data at predetermined intervals, whether or not there is a substantial change. In some examples, the sensor pod can be incorporated into a network of various mechanical or electronic devices used as a whole to monitor shipping containers. For example, U.S. patent application Ser. No. 13/631,063, the entirety of which is incorporated herein by reference, describes how one or more sensor pods can be used in conjunction with a “container monitoring device” (CMD) to seal and monitor shipping containers. Although the following description of the sensor pod is provided in the context of its application with sealed shipping containers and CMDs, it will be appreciated that the sensor pod can be adapted for use in numerous other types of applications without departing from the spirit of the invention.

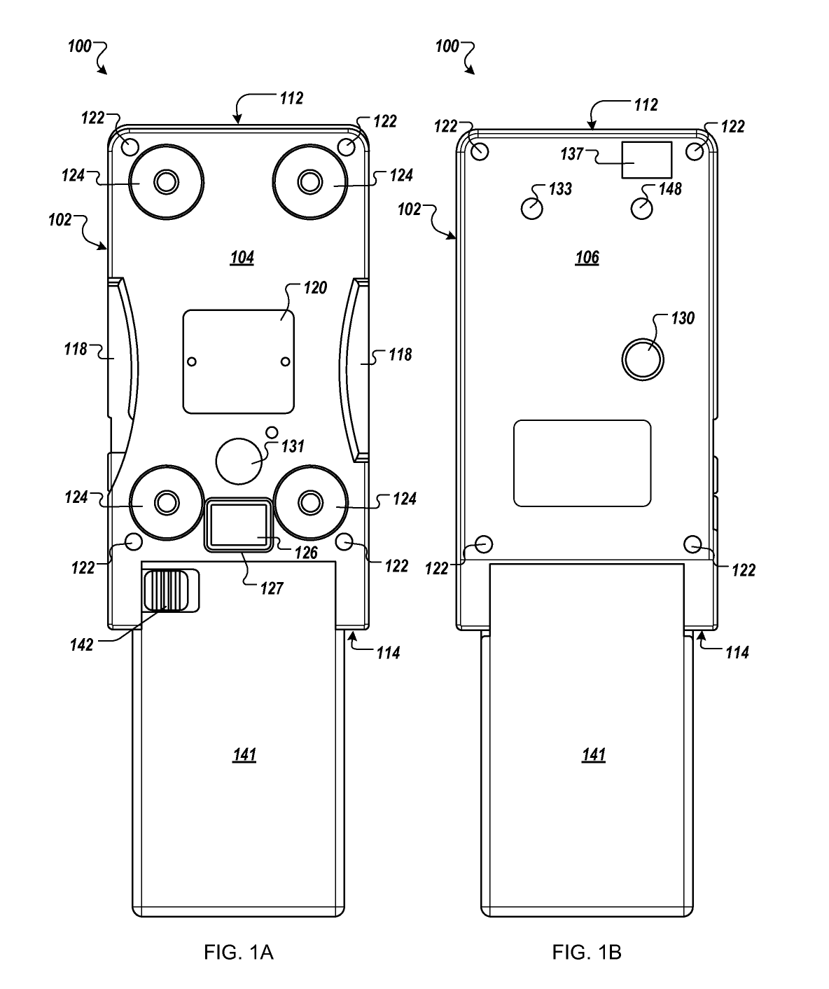

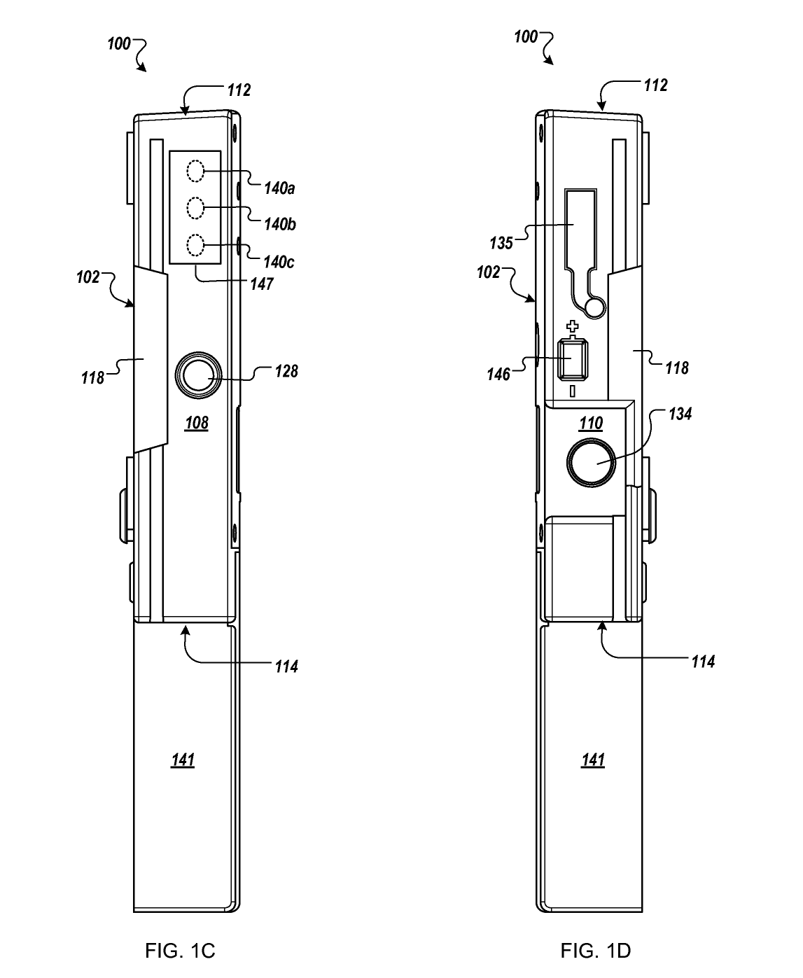

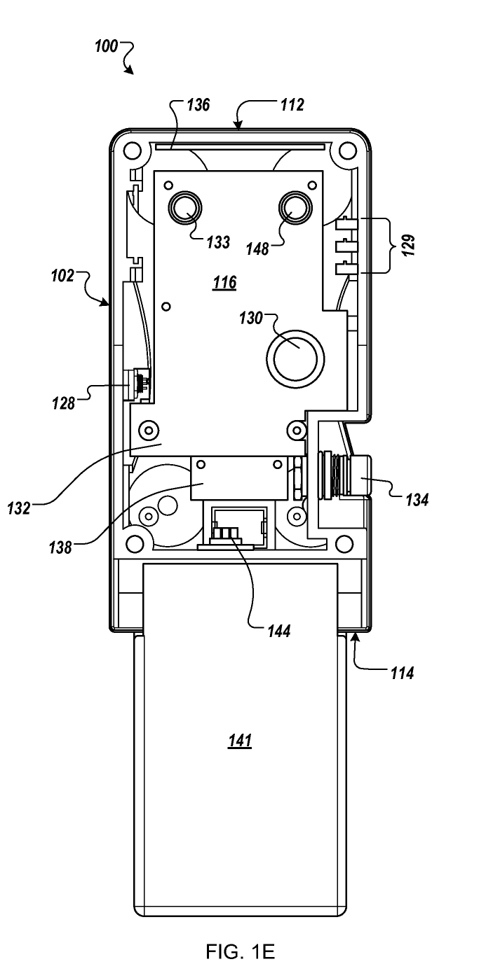

Referring to FIGS. 1A-1E, a sensor pod 100 features a quadralaterally shaped housing 102 having four outer faces 104-110 (namely, a back face 104, a front face 106, a left face 108, and a right face 110), as well as a top end 112 and a bottom end 114, that define an interior cavity 116. The housing 102 defines two opposing hand-hold recesses 118 to facilitate gripping and handling of the sensor pod 100. As shown in FIG. 1A, the recesses 118 extend inward from the left and right faces 108 and 110, and are adjacent the back face 104.

In the case of shipping containers, where the enclosure or its contents is expected to shift and move during transit, the sensor pod can be securely affixed to an interior surface of the shipping container (e.g., a wall, floor, or bulkhead), or to a surface of the cargo in the shipping container (e.g., a palette, box, crate, drum, etc.).

Accordingly, the housing 102 defines multiple through holes 122 positioned, e.g., one hole 122 near each of its four corners. Mechanical fasteners, e.g., bolts, can be inserted through the holes to mount the sensor pod to a surface inside an enclosure.

As an additional or alternative means of attachment to the surface inside the enclosure, the sensor pod 100 includes multiple magnets 124. The magnets 124 are incorporated into the back side 104 of the housing 102 and positioned proximate the through holes 122, near the four corners of the housing. The combined strength of the magnets 124 is sufficient to hold the weight of the housing 102 and other components of the sensor pod 100 against a ferromagnetic or paramagnetic surface.

The sensor pod 100 can be designed to determine if the housing 102 has been detached from the surface. For example, in this case, an infrared sensor 126 is configured to perform monitoring through a port 127 through the back face 104 of the housing 102. The port 127 of the infrared sensor 126 is positioned between two of the magnets 124. The infrared sensor 126 can include an emitter that generates an infrared light beam and a detector that receives reflections of the infrared light. The proximity of the housing's back face 104 relative to an interior surface is determined (e.g., by a monitoring subsystem incorporated into an onboard computing system) based on the received infrared light reflections. If the relative distance between the back face 104 and the interior surface changes, then the sensor pod 100 can generate a signal to a monitoring system, e.g., the CMD, that the sensor pod 100 has been disturbed. In addition, if the distance increases beyond a predetermined threshold, it is presumed that the housing 102 has been detached from the surface, and the sensor pod 100 can generate a different signal to the monitoring system. Of course other appropriate types of proximity sensors can be used for this purpose. For example, the sensor pod 100 could be modified by incorporating mechanical, acoustic, capacitive, or inductive proximity sensors in lieu of, or in addition to, the infrared sensor 126.

As noted above, the sensor pod 100 is designed to monitor environmental conditions inside a sealed enclosure. Accordingly, the sensor pod 100 features an environmental sensor 130 accommodated by the front face 106 of the housing 102. The environmental sensor can be responsive to numerous types of changes in the physical environment surround the sensor pod 100. In one example, the environmental sensor 130 is designed to sense changes in the temperature and/or humidity surrounding the sensor pod 100. In some other examples, the temperature and humidity can each be monitored using separate sensors. For example, the temperature sensor can be a thermometer and the humidity sensor can be a hygrometer.

The sensor pod 100 also features a light sensor 128 accommodated by the left face 108 of the housing 102. The light sensor 128 can be used to determine whether the sealed enclosure has been breached. For example, the light sensor 128 can include a photodetector for detecting changes in light intensity. When a substantial increase in light intensity is detected, it can be presumed that the enclosure has been breached, and the sensor pod 100 can generate a signal to the monitoring system. The increased light intensity signals that there has been an opening in the enclosure that allowed the additional light.

The sensor pod is designed to be extensible to incorporate various types of external sensors, in addition to any onboard sensors carried by the housing (e.g., the temperature, humidity, and light sensors described above). For instances, in this example, the sensor pod 100 includes multiple sensor ports 129 (e.g., data ports such as micro-USB, USB, RS232, RS485, CAN, etc.) that can connect the sensor pod with numerous different types of external sensors to monitor the sensor pod and its surroundings. The sensor ports 129 are protected by a cover plate 135 on the left face 108 of the housing 102.

The various sensors of the sensor pod 100 can be controlled and monitored by an onboard computing device 132 (shown schematically herein). The onboard computing device is activated and deactivated via switch actuated by an ON/OFF button 131 on the back face 104 of the housing 102. A status indicator light 133 on the front face 106 of the housing 102 provides a visual indication of the activated/deactivated state of the sensor pod 100. The onboard computing device 132 can include a main circuit board, and optionally one or more supplementary circuit boards held within the interior cavity 116 of the housing 102. In some examples, the main circuit board is a printed circuit board (PCB), which carries a number of computing and communication components. For example, the PCB can carry various chips, including computer memory, a receiver, a transmitter, a processor, a GPS module, as well as various other types of components and sensors. For instance, the PCB may support an accelerometer (not shown) or a shock sensor. When the sensor pod 100 is mounted directly to a cargo within a shipping container, output from the accelerometer can be used to determine if the cargo has been moved during transit. In addition, the accelerometer can serve as a redundancy to the infrared proximity sensor 126 in determining whether the device has been dislodged from its mounted surface. The main circuit board can be used to control various electrical components incorporated into the sensor pod 100.

The onboard computing device 132 is integrated with a data link port 134 including a conventional plug interface that is directly connected to one or more components (e.g., a processor) supported on the PCB. The data link port 160 allows one or more external computing devices to access the onboard computing device 132. In some examples, the data link port 134 is configured to allow one-way transfer of data from the onboard computing device 132 to an external device, while inhibiting data transfer from the external device to the onboard device. This type of configuration can inhibit tampering with the onboard computing device 132 by preventing the upload of potentially harmful data packets by an external device.

The sensor pod 100 is designed to transmit environmental data to an authorized receiver. The authorized receiver can be a container monitoring system in relatively close proximity to the sensor pod 100, or a remote server located hundreds or thousands of miles away. In some examples, information identifying one or more authorized receivers is preloaded into computer memory of the onboard computing device 132.

The sensor pod 100 includes an antenna 136 disposed within the interior cavity 116 to enable data transmission to an authorized receiver. The antenna 136 can enable short range radio communication (e.g., with other sensor pods or with a CMD). For example, the antenna 136 can enable short range communication via WPAN protocols, such as Bluetooth, ZigBee, or any other wireless networking protocol. The antenna 136 can also enable long range communication (e.g., with a remote server, or GPS satellites). For example, the antenna 136 can enable long range communication via a cellular network (e.g., such as a GSM, CDMA, HSDPA, LTE, GPRS, 2G, 3G, or 4G networks), a Satcomm network (e.g. Orbcomm, Iridium, Globalstar, Inmarsat networks) or any other data network that utilizes a radio access technology to wirelessly transmit data. A secondary circuit board (not shown) may support a removable subscriber identity module (SIM) card 138 that facilitates communication over wireless radio access technology networks. The SIM card 138 can be connected to a processor supported on the PCB of the onboard computing device 132. A user can access the SIM card by removing the cover plate 120 on the back face 104 of the housing 102.

Status indicator lights 140a, 140b, and 140c are controlled by the onboard computing device 132. Each of the status indicator lights 140a, 140b, and 140c correspond to a respective type of wireless communication. The status indicator light 140a provides a visual indication as to whether the sensor pod 100 is engaged in GPS communication; the status indicator light 140b provides a visual indication as to whether the sensor pod 100 is engaged in cellular or Satcomm communication (e.g., GSM, Orbcomm, etc.); and the status indicator light 140c provides a visual indication as to whether the sensor pod 100 is engaged in WPAN communication (e.g., ZigBee). The status indicator lights 140a, 140b, and 140c can be accessed by removing the cover plate 147 on the right face 110 of the housing 102.

In some examples, the sensor pod can be associated or paired with an authorized receiver (e.g., a CMD) onsite. Once associated, the sensor pod 100 can communicate wirelessly with the receiver to relay sensor data and/or events. In some examples, the onboard computing device 132 is configured to control outgoing communications, such that all outgoing communications are directed only to the paired receiver. The sensor pod 100 can include a near field communication (NFC) chip or a radio frequency identification (RFID) tag 137 (shown here on the front face 106 of the housing 102) to facilitate pairing with an authorized receiver. In this case, when a user wishes to associate the sensor pod 100 to an authorized receiver, the user can move the sensor pod 100 to within a specified distance (e.g., six centimeters) of the receiver. The receiver, which includes a tag reader, can scan the NFC chip or the RFID tag 137 installed in the sensor pod 100 to determine the identity of the sensor pod and associate the sensor pod to the receiver. Disassociation of the sensor pod 100 with the receiver can be accomplished in a similar manner; that is, by moving the sensor pod within the specified distance of the receiver. Association and disassociation of the sensor pod 100 to an authorized receiver can also be accomplished using a Bluetooth, ZigBee or other network interface.

The electrical components of the sensor pod 100 are powered by an onboard battery pack 141 (e.g., a lithium-ion battery pack). During use, the battery pack 141 is releasably attached to the bottom end 114 of the housing 102. In this example, a quick connect locking mechanism with a slide release (142) is used to facilitate attachment and detachment of the battery pack 141 from the housing 102. A connector 144 disposed within the interior cavity 116 is used to connect the battery pack 141 to the various electrical components installed in the sensor pod 100. The battery pack 141 can be swapped for any number of different battery packs with the same or differing power capacities. For example, the sensor pod 100 might be provided with an assortment of replaceable battery packs have different standard power capacities, which may be appropriate for different applications. For instance, in some applications, the sensor pod can be configured with different types of measurement and reporting schemes. That is, the sensor pod can be configured to take measurements and/or report measurements or events more or less frequently. The frequency of measurement and reporting affects battery usage, and therefore the required battery capacity.

In some examples, the sensor pod 100 can include battery sensor (not shown). The battery sensor can determine the charge remaining on the battery pack 141. The onboard computing device can control a battery status indicator light 146 based on feedback from the battery sensor. The battery status indicator light 146 can provide a visual indication of the remaining battery life of the battery pack 141.

The onboard computing device 132 is configured to monitor the environmental conditions proximate the sensor pod 100 and to report the environmental conditions to an associated receiver. As one example, the onboard computing device 132 can report environmental conditions as sensor data upon request from a receiver, or at predetermined time intervals (e.g., every five minutes, every ten minutes, etc.). As one other example, the onboard computing device can report environmental conditions as events (e.g., alert signals). For example, the onboard computing device 132 may report an event to the receiver when any of the monitored environmental conditions (e.g., temperature, humidity, light, or acceleration) have crossed (e.g., become greater than, become less than) a predetermined threshold (e.g., a limit value, a high value, a low value, etc.). In some examples, the reported events can be time dependent. For instance, the computing device 132 may report an event when a monitored environmental condition has crossed a predetermined threshold and remained across the threshold for a period of time (e.g., five minutes, ten minutes, etc.).

The onboard computing device 132 can be configured to monitor and report the physical state of the housing 102. For example, via the infrared sensor 126, the onboard computing device 132 can monitor and report a detachment event. Further, via the accelerometer 133, the onboard computing device 132 can record and report significant impacts, drops, or crashes of the housing 102.

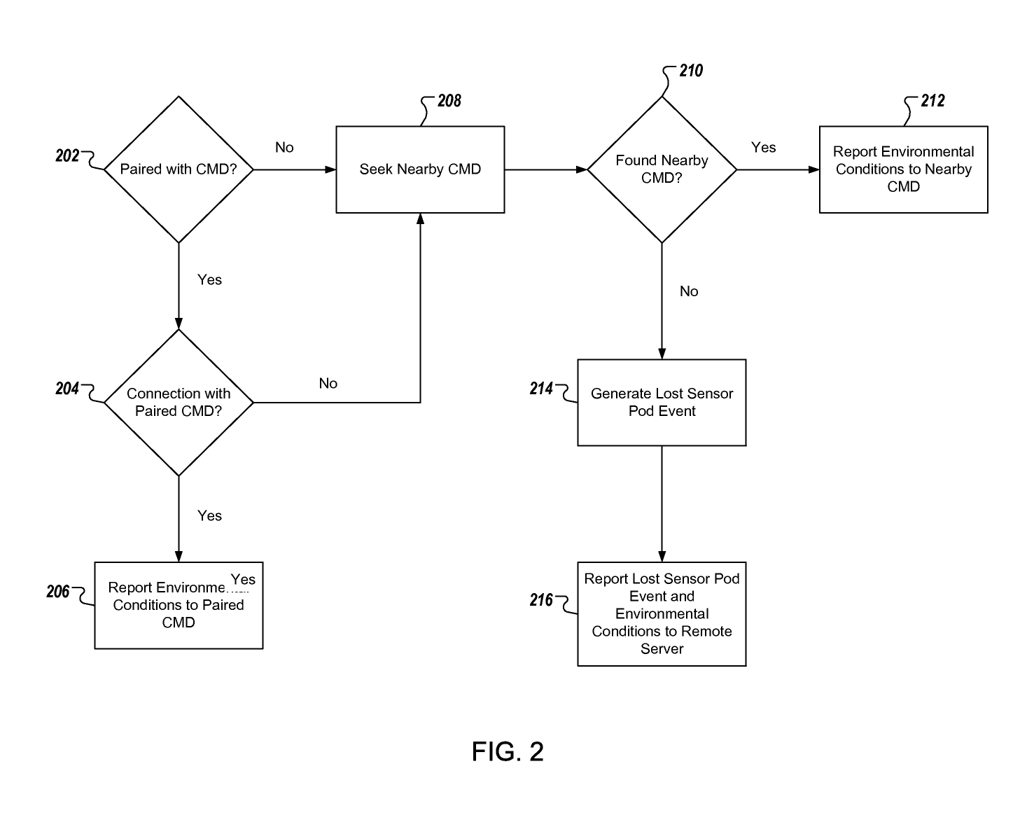

The onboard computing device 132 can be configured to implement a communication control protocol. FIG. 2 illustrates an example communication control protocol 200 that can be implemented by the onboard computing device 132. At step 202, the onboard computing device 132 determines whether the sensor pod 100 is currently paired with a container monitoring system. For example, the onboard computing device 132 may determine whether a received message matches an ID of the RFID tag 137. If the sensor pod 100 has been previously paired, at step 204 the onboard computing device 132 will attempt to establish a connection with the paired container monitoring system. If the connection is successfully established, at step 206 the onboard computing device 132 will report environmental conditions to the paired container monitoring system using short range wireless communications (e.g., via the WPAN transceiver). If the connection is not successfully established (e.g., if it is determined that no communication has been received from the paired CMD for longer than a predetermined period of time), or if the sensor pod has not been previously paired with a CMD, at step 208 the onboard computing device 132 will actively seek another nearby CMD and establish a connection. If a nearby CMD is found, at step 210, the onboard computing device 132 will report environmental conditions to the found CMD using short range wireless communications, at step 212. In some examples, the onboard computing device 132 will report the pairing event with the new CMD to a remote server. If a nearby CMD is not found, at step 210 the onboard computing device 132 will generate an event to indicate that the sensor pod has been forgotten or lost, at step 214. A status indicator light 148 on the front face 106 of the housing 102 provides a visual indication that that the sensor pod has not been able to establish a connection with a nearby CMD. In addition, at step 216 the onboard computing device 132 will report the sensor pod lost event and environmental conditions directly to a remote server device using long range wireless communications (e.g., via the cellular or Satcomm network transceiver). In some examples, the onboard computing device will report the current GPS location of the sensor pod 100 to the remote server.

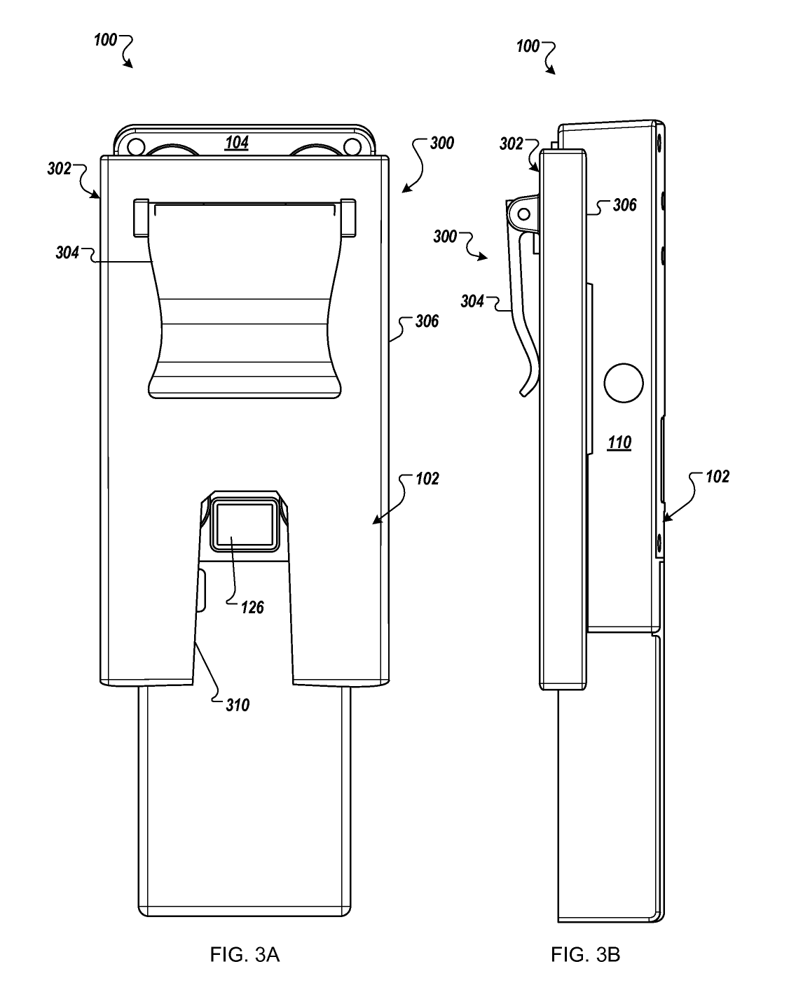

FIG. 3 shows an elective clip assembly 300 that can be secured to the back face 106 of the housing 102. The clip assembly 300 can be used, for example, to attach the housing 102 to a piece of cargo held within a shipping container. The clip assembly 300 includes a frame 302 and a clip 304 pivotally mounted to the frame. The frame 302 can be detachably secured to the housing 102 by sliding the outer rails 306 of the frame upward along the sides 108 and 110 of the housing. In some implementations, the frame 302 clicks into place on the housing 102 via a snap or detent type of connection. As shown, the clip assembly 300 is situated on the housing 102 to cover the back face 104 without blocking the infrared sensor 126. For example, the rim of the frame 302 can have a recess 310. In some implementations, the clip assembly 300 is configured so that when situated on the housing 102 the frame 302 does not block or the ON/OFF button 131.

The clip 304 is movable between a first position parallel and at zero-degrees relative to the frame (as shown), and a second position at ninety-degrees relative to the frame. A snap/detent connection is used to hold the clip 304 in either of the first or second positions. The first position is useful, for example, when the clip 304 and frame 302 are used to pinch a layer of cellophane (or other wrapping material) covering the cargo. The second position is useful, for example, when the clip 304 is wedged between two adjacent cargos, e.g., between two stacked cases or palettes.

The use of terminology such as “front,” “back,” “top,” “bottom,” “over,” “above,” and “below” throughout the specification and claims is for describing the relative positions of the various components described herein. Unless otherwise stated explicitly, the use of such terminology does not imply a particular position or orientation of any components relative to the direction of the Earth gravitational force, or the Earth ground surface, or other particular position or orientation that the system, and other elements may be placed in during operation, manufacturing, and transportation. In addition, the positions and orientations of the various passages, openings, switches, ports, display elements in or on the housing as described above are merely exemplary, and can be located at other positions or with other orientations.

A number of embodiments of the invention have been described. Nevertheless, it will be understood that various modifications may be made without departing from the spirit and scope of the inventions. For example, various sensors to monitor the status of the sensor pod and the surrounding environment have been described. Of course, various other types of sensors can be incorporated directly into the sensor pod as well. For example, the sensor pod can include—either internally or externally—a gyroscope, a vibration sensor, an ammonia sensor, a carbon dioxide sensor, a fumigant sensor, a radiation sensor, a pressure sensor, a motion sensor, a sound sensor, a still shot camera, a video camera, and an ambient radio frequency sensor, as well as many other types of sensors.

What is claimed is:

1. A sensor pod, comprising:
a housing defining an interior cavity;
a fixture configured to attach the housing to a surface;
an infrared sensor in the cavity configured to monitor infrared light through a first port in the housing; and
a monitoring system disposed in the interior cavity and configured to receive a signal from the infrared sensor and determine whether the housing has been detached from the surface based on the signal, and to generate an alert signal when the housing is determined to have been detached from the surface.

2. The sensor pod of claim 1, wherein the fixture comprises at least one magnet positioned on a back face of the housing.

3. The sensor pod of claim 2, wherein the at least one magnet comprises a plurality of magnets, and the first port is positioned between the magnets.

4. The sensor pod of claim 1, wherein the fixture comprises mounting hardware.

5. The sensor pod of claim 1, wherein the fixture comprises a clip assembly having a frame and a clip, the frame configured to be slidably and detachably secured to the housing without blocking the port, the clip pivotally mounted to the frame.

6. The sensor pod of claim 1, wherein the light sensor configured to monitor through port in the housing.

7. The sensor pod of claim 6, further comprising a temperature sensor other than the IR and light sensor.

8. The sensor pod of claim 1, wherein the alert signal is a wireless signal.

9. The sensor pod of claim 1, wherein the housing has two opposing side faces, each of the side faces defining a recess adjacent a back side of the housing for user to grip and detach the housing from the surface.

10. The sensor pod of claim 1, further comprising a temperature and humidity sensor.

11. The sensor pod of claim 1, further comprising a battery status sensor and a batter status indicator.

12. The sensor pod of claim 1, further comprising a sensor configured to monitor a physical status of the housing, the sensor being selected from the group consisting of an accelerometer, a gyroscope, a vibration sensor, and a shock sensor.

13. The sensor pod of claim 1, further comprising a sensor configured to monitor a surrounding environment of the housing, the sensor being selected from the group consisting of an ammonia sensor, a carbon dioxide sensor, a fumigant sensor, a radiation sensor, and a pressure sensor.

14. The sensor pod of claim 1, further comprising a security sensor being selected from the group consisting of a motion sensor, a sound sensor, a still shot camera, a video camera, and an ambient radio frequency sensor.

15. A sensor pod, comprising:
a housing defining an interior cavity;
a sensor in the cavity configured to sense one or more of temperature, humidity, acceleration/shock or visible light through a port in the housing;
an RFID tag;
a wireless personal area network transceiver in the cavity;
a network transceiver in the cavity;
a communication control system in the cavity, the communication control system configured to
i) determine whether a remote device is associated with the sensor pod by detecting whether a message from the remote device received wireless personal area network transceiver by the matches an ID of the RFID card, and establish communication through the wireless personal area network transceiver with the associated remote device;
ii) determine whether no communication has been received from an associated remote device for longer than a first preset time period, and attempt to establish communication through the wireless personal area network transceiver with another remote device, and
iii) determine whether no communication through the wireless personal area network transceiver has been established with the another remote device, and attempt to establish communication with a remote server via the network transceiver.

16. The sensor pod of claim 15, wherein the communication control system is further configured to send measurements made by the sensor to whichever of the associated remote device, another remote device and remote server with which communication has been established.

17. The sensor pod of claim 15, wherein the wireless personal area network transceiver comprise a Zigbee transceiver.

18. The sensor pod of claim 15, wherein the network transceiver comprises a cellular network transceiver.

19. The sensor pod of claim 15, wherein the network transceiver comprises a Satcomm transceiver.

20. A sensor pod kit, comprising:
a sensor pod including a housing defining an interior cavity and a sensor in the cavity configured to sense one or more of temperature, humidity or visible light through a port in the housing; and
a clip assembly having a frame and a clip, the frame configured to be slidably and detachably secured to the housing without blocking the port, the clip pivotally mounted to the frame.

21. The sensor pod kit of claim 20, wherein the clip is movable between a first position substantially perpendicular to the frame and a second position substantially parallel to the frame.

22. The sensor pod kit of claim 21, further comprising a snap mechanism to hold the clip in the first position or the second position.

23. The sensor pod kit of claim 20, wherein the frame is configured to surround the housing when secured to the housing.

24. The sensor pod kit of claim 23, wherein the housing is generally a rectangular solid, frame has opposing rails that slide along two sides of the housing.

25. The sensor pod kit of claim 20, further comprising a snap mechanism to hold the frame on the housing.

26. The sensor pod kit of claim 20, further comprising an infrared sensor in the cavity configured to monitor infrared light through a port in a back side of the housing.

27. The sensor pod kit of claim 26, wherein the frame defines a recess extending from a lower edge so that the infrared sensor is not covered when the clip assembly is attached to the housing.

28. The sensor pod kit of claim 20, further comprising at least one other sensor disposed within the interior housing and configured to sense acceleration, vibration or shock.

29. The sensor pod kit of claim 20, further comprising a battery pack configured to be releasably coupled to the housing to power the sensor.

30. The sensor pod kit of claim 20, further comprising an assortment of battery packs, each battery pack of the assortment having a different power capacity.
